(19) United States
(12) Patent Application Publication
(10) Pub. No.: US 2025/0317907 A1
(43) Pub. Date: Oct. 9, 2025

(54) CROSS-LINK INTERFERENCE CONTROL FOR AMBIENT INTERNET OF THINGS (AIOT)

(71) Applicant: Apple Inc., Cupertino, CA (US)

(72) Inventors: Huaning Niu, San Jose, CA (US); Sigen Ye, San Diego, CA (US); Wei Zeng, Saratoga, CA (US); Haitong Sun, Saratoga, CA (US); Dawei Zhang, Saratoga, CA (US); Ankit Bhamri, Haar (DE); Hong He, San Jose, CA (US); Chunxuan Ye, San Diego, CA (US)

(21) Appl. No.: 19/068,209

(22) Filed: Mar. 3, 2025

Related U.S. Application Data
(60) Provisional application No. 63/574,300, filed on Apr. 4, 2024.

(51) Int. Cl. H04W 72/044; H04W 72/21; H04W 76/27

(52) U.S. Cl. CPC H04W 72/044; H04W 72/21; H04W 76/27

(57) ABSTRACT

In one aspect, an intermediate node connects an Ambient Internet of Things (AIoT) device and a base station. When executing instructions stored in a memory, a baseband processor of the intermediate node is configured to: decode control information received from the base station to schedule a first set of time resources for AIoT data, and encode or decode the AIoT data for communicating with the AIoT device using the first set of time resources. The first set of time resources is not scheduled for uplink transmission to the base station.

### REFERENCE TO RELATED APPLICATIONS

This Application claims the benefit of U.S. Provisional Application No. 63/574,300, filed on Apr. 4, 2024, the contents of which are hereby incorporated by reference in their entirety

### FIELD

This disclosure relates to wireless communication networks including techniques for AIoT (Internet of Things).

### BACKGROUND

Internet of Things (IoT) is a network of physical devices that can connect and exchange data with other devices and systems over the internet via wired or wireless networks. AIoT is a use case of low-power wide-area (LPWA) IoT, where battery-free devices harvest energy from ambient energy sources like light, motion, radio waves, heat, or other sources. As an example, ambient IoT devices may backscatter radio waves and send sensing or identity data to wireless devices like phones, smart speakers, smart cameras, Wi-Fi access points, or electronic shelf labels. AIoT is an alternative to RFID and has the potential to enable a number of connections and/or device density orders of magnitude higher than existing 3rd Generation Partnership Project (3GPP) IoT technologies. AIoT can provide complexity and power consumption orders-of-magnitude lower than existing 3GPP LPWA technologies such as NB (narrow band)-IoT and LTE-MTC (Long-Term Evolution Machine Type Communication).

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1A is a block diagram illustrating a wireless network including an intermediate node configured to communicate with a base station over an access link and communicate with an Ambient Internet of Things (AIoT) device over an AIoT link in accordance with some aspects of the present disclosure.

FIG. 1B is a schematic diagram illustrating resource allocation of AIoT communication in accordance with some aspects of the present disclosure.

FIG. 2 is a schematic diagram illustrating configuration signaling for communicating AIoT data in accordance with some aspects of the present disclosure.

FIG. 3 is a schematic diagram illustrating AIoT data resource configuration in accordance with some aspects of the present disclosure.

FIG. 4 is a schematic diagram illustrating configured scheduling signaling for communicating AIoT data in accordance with some aspects of the present disclosure.

FIG. 5 is a schematic diagram illustrating dynamic scheduling signaling for communicating AIoT data in accordance with some aspects of the present disclosure.

FIGS. 6A-6B and 7A-7B are schematic diagrams illustrating resource allocation of AIoT communication on uplink resources in accordance with some aspects of the present disclosure.

FIGS. 8A-8B and 9-10 are schematic diagrams illustrating resource allocation of AIoT communication on respective uplink and downlink resources in accordance with some aspects of the present disclosure.

FIG. 11 is a process flow for an intermediate node to communicate an AIoT data with an AIoT device in accordance with some aspects of the present disclosure.

FIG. 12 is a process flow for a base station to schedule an AIoT communication between an intermediate node and an AIoT device in accordance with some aspects of the present disclosure.

FIG. 13 is a block diagram illustrating a wireless network including an intermediate node configured to communicate with a base station over an access link and communicate with an Ambient Internet of Things (AIoT) device over an AIoT link in accordance with some aspects of the present disclosure.

FIG. 14 is a block diagram illustrating a device that can be employed to perform AIoT data resource allocation in accordance with some aspects of the present disclosure.

FIG. 15 is a block diagram illustrating baseband circuitry that can be employed to perform AIoT data resource allocation in accordance with some aspects of the present disclosure.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

As a use case of low-power wide-area (LPWA) Internet-of-Things (IoT), Ambient IoT (AIoT) extends wireless network to even more connections with higher device density and lower complexity and power consumption than existing 3GPP LPWA technologies such as narrowband (NB)-IoT or Machine Type Communication (MTC). Because of the further lower power consumption of the AIoT devices than other MTC devices or IoT devices, interference from another stronger communication is more significant and detrimental to AIoT communication.

Some aspects of the present disclosure relate to cross-link interference control in case of an AIoT communication sharing carrier frequency with an access link of the conventional cellular network. More details are described below with referenced to figures.

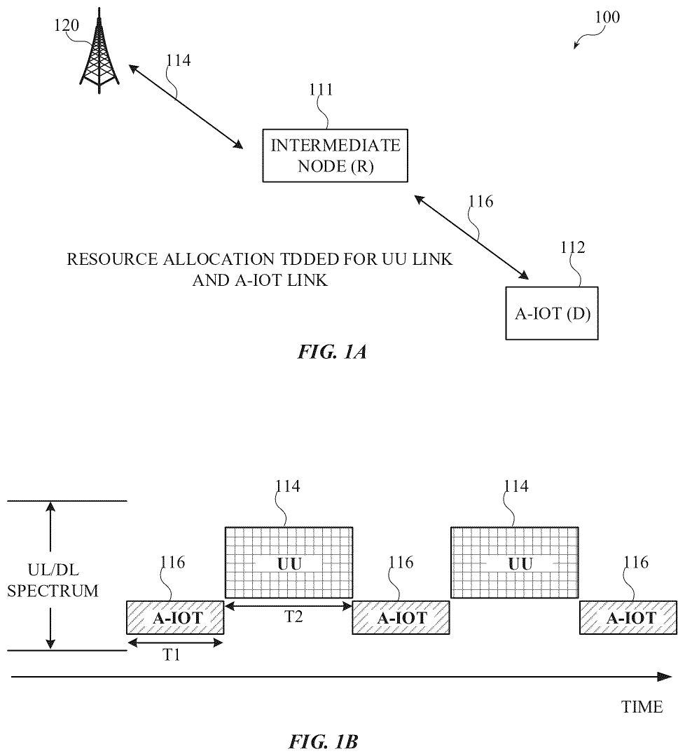

FIG. 1A shows a block diagram of an AIoT wireless network 100, illustrating a cross-link interference issue of AIoT communication. FIG. 1B shows a schematic diagram illustrating resource allocation of an AIoT link 116 in accordance with some aspects of the present disclosure. Referring to FIG. 1A as an example, one of connectivity topologies of the AIoT wireless network 100, referred as Topology 2 by 3rd Generation Partnership Project (3GPP) studies, includes an intermediate node 111 configured to perform bidirectional communication with a base station 120 over an access link 114 and perform bidirectional communication with an AIoT device 112 over the AIoT link 116. The intermediate node 111 relays data and/or control signaling from the base station 120 to the AIoT device 112 and also as an AIoT reader for the AIoT device 112. The intermediate node 111 can be a relay device, an integrated access and backhaul (IAB) node, a user equipment (UE), a repeater, etc. which is capable of AIoT communication. The intermediate node transfers Ambient IoT data and/or signaling between BS and the Ambient IoT device.

As shown in FIG. 1B, when the AIoT link 116 uses uplink spectrum and/or downlink spectrum of the access link 114, a cross-link interference arises since no sufficient frequency guard band may be placed for the access link resources and the AIoT link resources. In addition, since the tranceiving power of the AIoT link 116 is significantly smaller than tranceiving power of the access link 114, the AIoT communication is uniquely affected by the aforementioned cross-link interference compared to some other techniques with greater tranceiving power that use the uplink spectrum and/or the downlink spectrum. In view of the cross-link interference issue and in accordance with some aspects of the present disclosure, when communicating AIoT data on the AIoT link 116 between the intermediate node 111 and the AIoT device 112, the intermediate node 111 may not communicate on the access link 114 with the base station 120 such that the cross-link interference is mitigated. Scheduling coordination wise, when AIoT data communication on the AIoT link 116 is scheduled between the intermediate node 111 and the AIoT device 112, uplink or downlink communication may be refrained from being scheduled on the access link 114 between the intermediate node 111 and the base station 120. For example, the AIoT data may be arranged to communicate over a first set of time resources T1, while the access link data may be arranged to communicate over a second set of time resources T2 that is not overlapped with the first set of time resources T1.

More specifically, the scheduling restriction in the time domain relates to resource allocation in the frequency domain. For example, as described with further details below, in one approach, both directions of the AIoT communication from the AIoT device 112 to the intermediate node 111 (referred as D2R communication) and from the intermediate node 111 to the AIoT device 112 (referred as R2D communication) are arranged on the uplink spectrum, and the scheduling restriction may be placed on the uplink transmission from the intermediate node 111 and not necessarily on the downlink receiving of the intermediate node 111. In another approach, D2R communication is arranged on the uplink spectrum, while the R2D communication is arranged on the downlink spectrum. Then the scheduling restriction may be respectively placed on the uplink and the downlink communication of the intermediate node 111. Further, a carrier wave is provided to the AIoT device 112 by either the intermediate node 111 or another node. When the carrier wave is provided by the intermediate node 111, the carrier wave may be arranged on the uplink spectrum of the access link, and the corresponding scheduling restrictions to the uplink spectrum applies. The carrier wave may also be arranged on the downlink spectrum of the access link, and the corresponding scheduling restrictions to the down link spectrum applies. The avoidance of scheduling and communicating the uplink or downlink when the AIoT data communication is scheduled may have an acceptable consequence on the access link communication, since the AIoT data usually has a limited amount and complexity due to the unique device characters of the AIoT devices and thus may not take significant resources from the access link.

In some aspects, an AIoT wireless network may have multiple connectivity topologies including Topology 2 discussed above. The AIoT wireless network may include other connectivity topologies such as Topology 1 where the AIoT device directly perform bidirectional communication with a base station or Topology 3 where the AIoT device directly communicates with a base station on one direction (downlink or uplink) and indirectly communicates with the base station on the other direction (uplink or downlink) via an assisting node. Various resource scheduling techniques discussed throughout this disclosure may be similarly applied to Topology 3 as well.

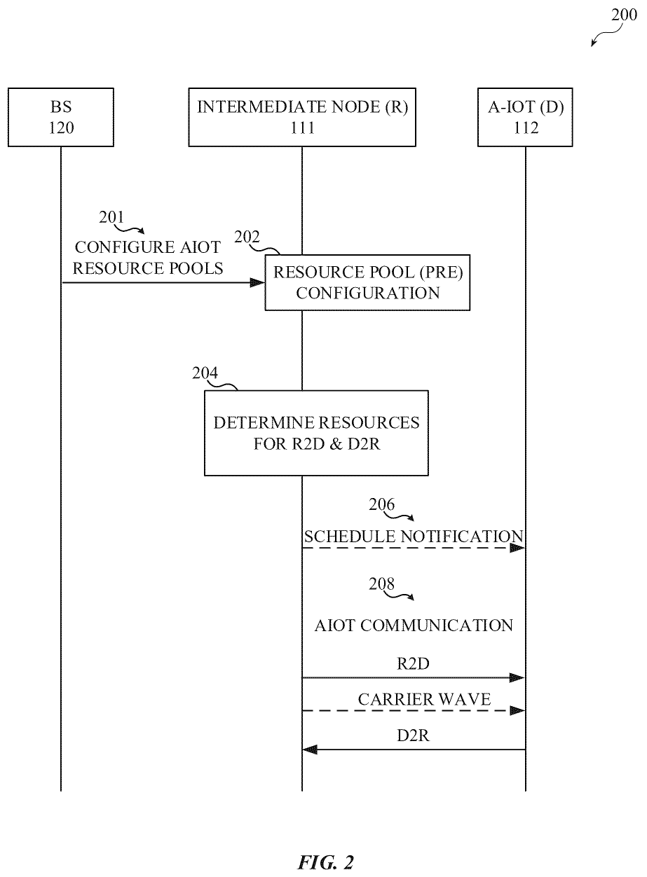

FIG. 2 shows a schematic diagram that illustrates signaling 200 for communicating AIoT data in accordance with some aspects of the present disclosure. The AIoT communication is performed in a Topology 2 AIoT wireless network including scheduling restrictions for cross-link interference control. The Topology 2 AIoT wireless network may be or be part of the AIoT wireless network 100 as described associated with FIG. 1. Throughout this specification, when a component is described with a numeral (e.g., base station 120, intermediate node 111, AIoT device 112 etc.), features and functions of the numerated component discussed associated with any figure may be incorporated into embodiments discussed elsewhere in the specification if applicable and may not be repeated for simplicity.

In some aspects, an intermediate node 111 receives control information from a base station 120 to allocate time-frequency resources for AIoT data and then communicates the AIoT data with an AIoT device 112 based on the allocated time-frequency resources. In some aspects, access link transmission between the intermediate node and the base station is time division multiplexed (TDMed) with the communication of the AIoT data. In some aspects, the allocated resources includes a first set of time resources that is not scheduled for uplink transmission from the intermediate node to the base station. An example of further details of the signaling is now provided with a series of acting steps. Unless stated as “essential” or “necessary”, one or more acting steps may be omitted or altered, and the intended functions can still be realized.

At act 201 or act 202, in some aspects, resource pool information may be provided to the intermediate node 111. The resource pool information indicates at least one resource pool including time and/or frequency resources for communicating AIoT data or for communicating D2R data and R2D data separately. Shown by act 201, in some aspects, the resource pool information may be included in a radio resource control (RRC) configuration or reconfiguration message communicated from the base station 120 to the intermediate node 111. Shown by act 202, in some alternative or additional aspects, initial resource pool information may be included in a resource pool pre-configuration (e.g., specified by 3GPP Standards) and stored in the intermediate node 111 or another storage medium without communicating with the base station 120. The initial resource pool information may also be updated by a RRC reconfiguration from the base station 120 if needed.

In some aspects, the resource pool information includes an AIoT resource pool including time and/or frequency resources for both D2R communication and R2D communication, and also carrier wave resources if transmitted by the intermediate node 111. The AIoT resource pool defines overall resources that can be used for AIoT communication within within a carrier. The AIoT resource pool may include a time resource indication indicating AIoT resources in the time domain and a frequency structure of sub-channels including resource blocks. The time resource indication is per time unit based, such as slot based or subframe based. As an example, the AIoT resource pool may consist of a set of slots repeated over a resource-pool period.

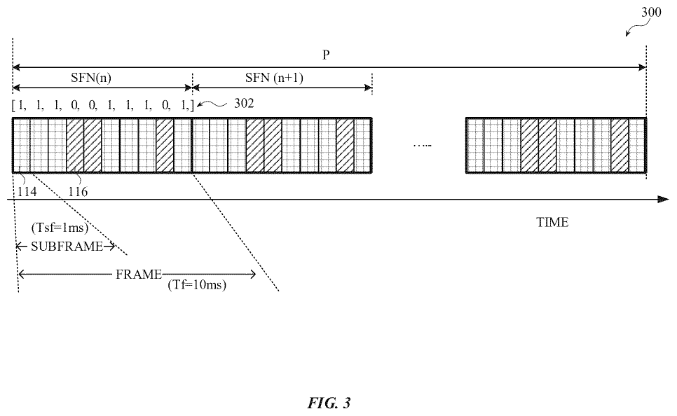

In some alternative aspects, the resource pool information includes separate D2R resource pool and R2D resource pool including time and/or frequency resources respectively for D2R communication and R2D communication. In the case of configuring separate D2R resource pool and R2D resource pool, the carrier wave resources may be included in the D2R resource pool, if the carrier wave is transmitted by the intermediate node 111. The D2R resource pool and the R2D resource pool may have identical resources configured. Before jumping to next act of FIG. 2, FIG. 3 is discussed first with more details of AIoT resource configuration.

FIG. 3 shows a schematic diagram illustrating AIoT data resource configuration in accordance with some aspects of the present disclosure. In some aspects, an AIoT resource pool 300 is configured with a resource pool periodicity P. A plurality of subframes, slots, or subslots usable for AIoT communication may be referenced by a bitmap to indicate whether corresponding subframes or slots are in the resource pool or can be used by the AIoT communication. The AIoT resource pool 300 may be defined by repeating a bitmap 302 with a resource pool periodicity. As an example, the periodicity of the bitmap 302 may be frame ordered by a system frame number (SFN), or a direct frame number (DFN) cycle when Global Navigation Satellite System (GNSS) is used as the synchronization reference. The bitmap 302 may have a number of bits mapped to a number of time units, such as slots with a slot index relative to slot #0 of a radio frame corresponding to a frame (e.g., SFN 0) of the serving cell. As an example, for a subcarrier spacing of 15 kHz, the resource pool periodicity P may be 10240 ms corresponding to 1024 frames of 10 ms, each with a 10-bit SFN index “N” numbered from 0 to 1023. Slot index is relative to slot #0 of the radio frame corresponding to SFN 0 of the serving cell. Each slot occupies one subframe of 1 ms. The length of the bitmap 302 is configurable, for example, from 10 to 130 bits. As an example shown in FIG. 3, the bitmap 302 may have 10 bits, e.g., [1, 1, 1, 0, 0, 1, 1, 1, 0, 1], that indicate slots for the access link 114 by value “1” and indicates slots for the IoT link 116 (R2D or D2R slots) by value “0”.

As shown in FIG. 3, configured or allocated resources in the time domain can be either continuous or non-continuous slots or subframes in a frame. Also, although the AIoT resource pool configuration may have a slot-based or subframe-based granularity, not all symbols of a configured slot are necessarily available for the AIoT communication. For example, AIoT symbols may also be multiplexed with access link control signaling if sharing a carrier frequency.

At act 204, the intermediate node 111 may determine time-frequency resources from the at least one resource pool. The intermediate node 111 may determine to receive D2R data or transmit R2D data by selecting time-frequency resources based on one AIoT resource pool including time and/or frequency resources for both D2R communication and R2D communication. Alternatively, the intermediate node 111 may determine to receive D2R data using resources selected from the D2R resource pool and determine to transmit R2D data using resources selected from the R2D resource pool.

At act 206, in some aspects, a schedule notification is transmitted from the intermediate node 111 to the AIoT device 112. The schedule notification may be optional depending on specific application of the AIoT device 112. The schedule notification may be transmitted to the AIoT device 112 separately or included as part of the R2D communication.

At act 208, the AIoT data is communicated between the intermediate node 111 and the AIoT device 112 using the time-frequency resources determined at act 204. As elaborated above, the time-frequency resources may be configured by a RRC message and determined or selected by the intermediate node 111. The intermediate node 111 may determine specific resources from an AIoT resource pool or separate D2R resource pool or R2D resource pool to transmit R2D data or receive D2R data. The intermediate node 111 may also determine resources from the AIoT resource pool or the D2R resource pool to transmit a carrier wave and receive a response of D2R data including modulation information on top of the carrier wave. As an example, the intermediate node 111 may transmit a message, such as a query message or a unicast command to the AIoT device 112. The AIoT device 112 may respond based on the scheduled notification or after a pre-defined time for processing. A listen-before-talk or other collision addressment measure may be applied for the AIoT device 112 to determine or select a time resources (e.g., a slot) to transmit the D2R data when multiple devices are involved.

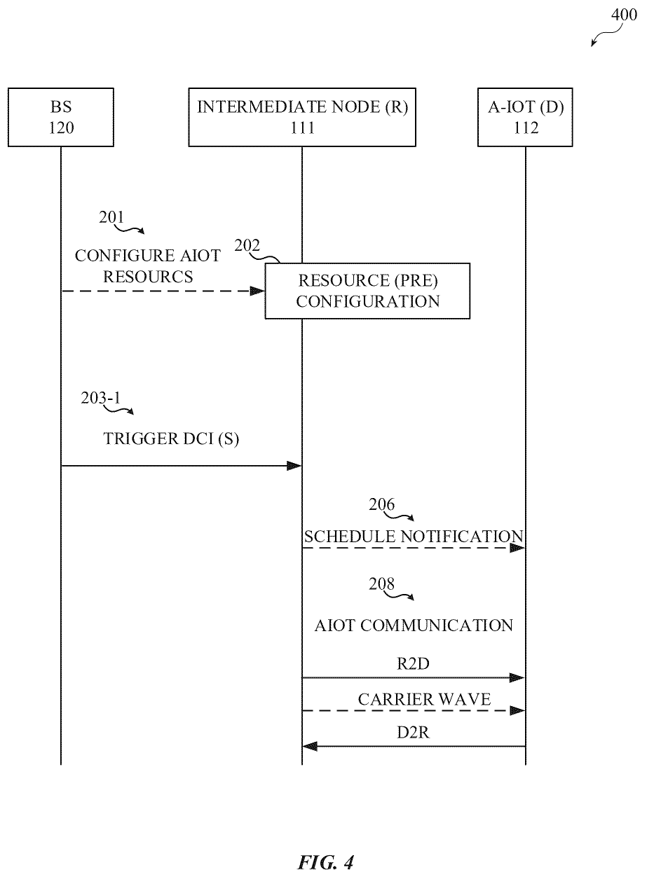

FIG. 4 shows a schematic diagram illustrating configured scheduling 400 for communicating AIoT data in accordance with some aspects of the present disclosure. Comparing the signaling 200 as described associated with FIG. 2 (where the AIoT communication is scheduled by configuring a AIoT resource pool), in some aspects, the AIoT communication may be scheduled by a configured scheduling process similar to configured grant type 2 for uplink scheduling of the access link or a semi-persistent scheduling (SPS) for downlink scheduling of the access link. The control information may include an AIoT resource configuration that configures AIoT resources for AIoT communication and an activation command that triggers the AIoT communication.

The AIoT resource configuration may be indicated in an RRC configuration or reconfiguration message from the base station 120 to the intermediate node 111 as shown by act 201. The RRC configuration or reconfiguration message may also update the AIoT resource configuration or pre-configuration as shown by act 202. As already discussed associated with FIG. 2, in some aspects, the AIoT resource configuration may include resource pool information including an AIoT resource pool including time and/or frequency resources for both D2R communication and R2D communication. In some alternative aspects, the resource pool information includes separate D2R resource pool and R2D resource pool including time and/or frequency resources respectively for D2R communication and R2D communication. Other details of the resource pool configuration described associated with FIG. 2 is incorporated herein and not repeated for simplicity.

As shown by act 203-1, the triggering command may be included in downlink control information (DCI) that triggers the communication of the AIoT data. In some aspects, a single DCI is used to activate or deactivate the communication of the AIoT data including the D2R data and the R2D data. The intermediate node 111 determines whether to receive the D2R or transmit the R2D. In some alternative or additional aspects, a first DCI is used to activate or deactivate D2R data of the AIoT data to be received from the AIoT device 112, and a second DCI is used to activate or deactivate R2D data of the AIoT data to be transmitted to the AIoT device 112.

In some alternative aspects, the RRC configuration or reconfiguration message includes a periodicity of the AIoT communication, and the triggering command specifies the resources for AIoT data to be used according to the periodicity.

At act 206, in some aspects, a schedule notification is optionally transmitted from the intermediate node 111 to the AIoT device 112. At act 208, the AIoT data is communicated between the intermediate node 111 and the AIoT device 112 using the time-frequency resources determined by acts 201, 202, and 203-1. Other applicable details of the act 206 and act 208 described associated with FIG. 2 is incorporated herein and not repeated for simplicity.

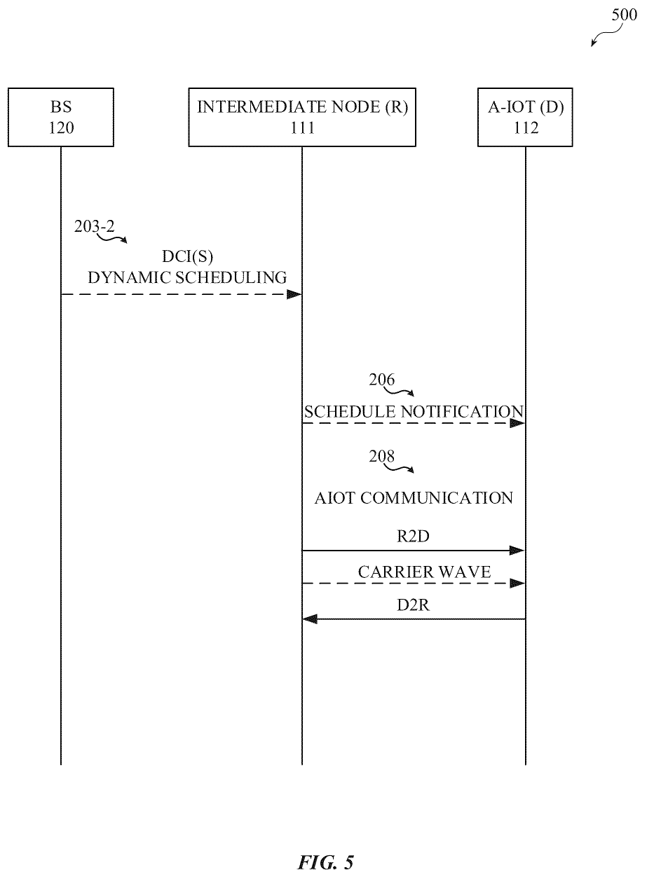

FIG. 5 shows a schematic diagram illustrating dynamic scheduling 500 for communicating AIoT data in accordance with some alternative aspects of the present disclosure. Comparing the signaling 200 as described associated with FIG. 2 (where the AIoT communication is scheduled by configuring a AIoT resource pool) and the configured scheduling 400 as described associated with FIG. 4 (where the AIoT communication is scheduled by a periodic resource configuration and a triggering command), in some aspects, the AIoT communication may be scheduled by a dynamic scheduling process where one or more DCIs are used as the control information to signal resources for AIoT communication. The one or more DCIs may indicate frequency resources and time resources for AIoT communication. The frequency resources and time resources may be communicated through resource indexes. The resource indexes may be mapped to allocated resources by a mapping relation communicated through a configuration.

As shown by act 203-2, a DCI is used to dynamically schedule the intermediate node 111 for each transmission interval (e.g., a slot or a subframe) for AIoT communication. The DCI may indicate starting and lasting time, such as a starting slot and a number of lasting slots, of a first set of time resources that are allocated for the AIoT communication or specifically for the D2R data. In some aspects, a single DCI is used to schedule the communication of the AIoT data including the D2R data and the R2D data. The intermediate node 111 determines whether to receive the D2R or transmit the R2D. In one aspect, the single DCI may indicate the intermediate node 111 on whether to receive the D2R or transmit the R2D. For example, the single DCI may include an indicator, such as a dedicated one bit indicator, to indicate whether the resources scheduled by the single DCI is for D2R or R2D. For example, if the one bit indicator has a value of “0”, the resources indicated in the single DCI is used to communicate the D2R data, while if the one bit indicator has a value of “1”, the resources indicated in the single DCI is used to communicate the R2D data. In some alternative or additional aspects, a first DCI is used to schedule the D2R data of the AIoT data to be received from the AIoT device 112, and a second DCI is used to schedule the R2D data of the AIoT data to be transmitted to the AIoT device 112. The DCIs used for the configured scheduling 400 and the dynamic scheduling 500 both use the physical downlink control channel (PDCCH) but with different identities for validation. At act 206, in some aspects, a schedule notification is optionally transmitted from the intermediate node 111 to the AIoT device 112. At act 208, the AIoT data is communicated between the intermediate node 111 and the AIoT device 112 using the time-frequency resources determined by acts 201, 202, and 203-2. Other applicable details of the act 206 and act 208 described associated with FIG. 2 is incorporated herein and not repeated for simplicity.

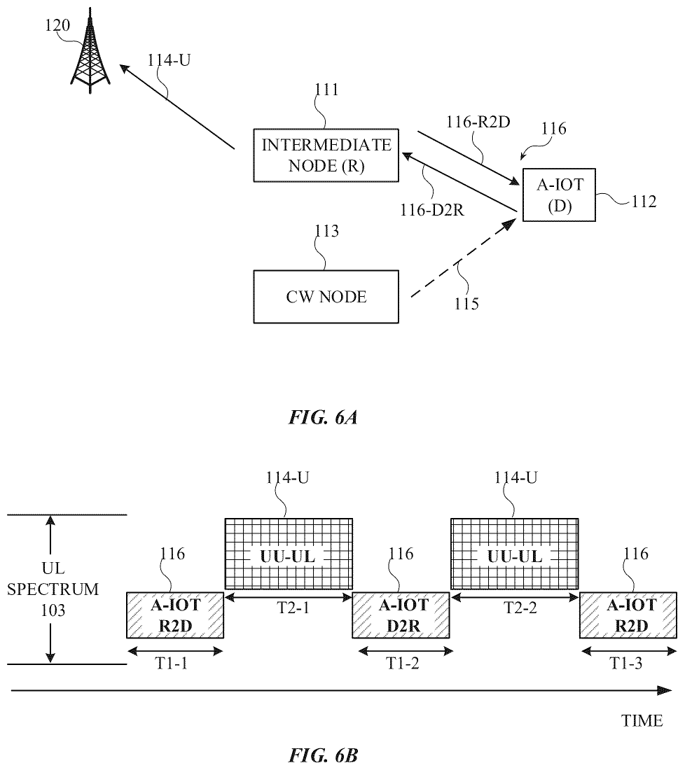

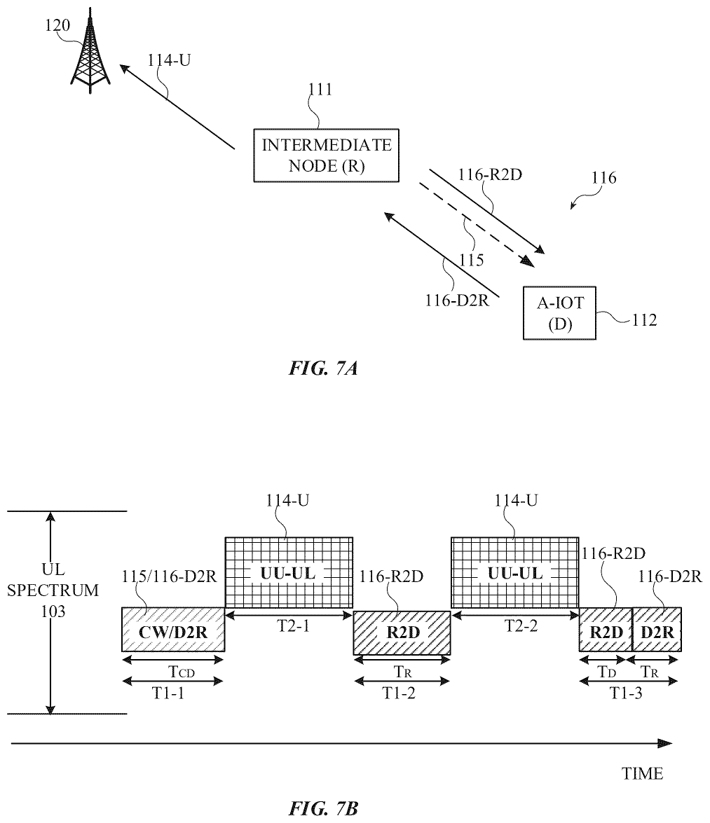

FIGS. 6A-6B and 7A-7B are schematic diagrams illustrating additional details of resource allocation on uplink resources for the AIoT communication in accordance with various aspects of the present disclosure. In some aspects, the AIoT link uses uplink resources in the uplink spectrum of an access link which causes an interference between the AIoT link and the uplink communication of the access link. As shown in FIG. 6A and FIG. 7A, a cross-link interference arises between the uplink communication 114-U and the AIoT link 116. In order to mitigate the cross-link interference, the scheduling restriction may be placed on the uplink communication 114-U while not necessarily on a downlink communication. As shown in FIG. 6B and FIG. 7B, when a first set of time resources (e.g., T1) is scheduled for the AIoT link 116 (e.g. by selecting resources from a AIoT resource pool as discussed above), or specifically for either the D2R communication 116-D2R or the R2D communication 116-R2D (e.g. by selecting resources from a D2R resource pool or a R2D resource pool as discussed above), the first set of time resources (e.g., represented by T1) is not scheduled for performing the uplink communication 114-U to the base station 120. As discussed above associated with FIGS. 2-5, the AIoT link 116 may be scheduled on periodic, semi-persistent or dynamic time resources Tl that is not overlapped with the scheduled time resource T2 of the uplink communication 114-U. The uplink communication 114-U may be time division multiplexed (TDMed) with the communication of the AIoT data including the D2R communication 116-D2R or the R2D communication 116-R2D.

In some aspects, as shown in FIG. 6B, the time resources T1 (e.g., T1-1, T1-2, T1-3) are scheduled for the AIoT link 116. The intermediate node 111 determines the resource allocation for the D2R communication 116-D2R and the R2D communication 116-R2D. As an example, a periodical resources in the uplink spectrum 103 may be scheduled for the AIoT link 116, and a first time resource T1-1 is allocated to the R2D data, a second time resource T1-2 is allocated to the D2R data, and a third time resource T1-3 is allocated to the R2D data.

In some aspects, as discussed associated with FIG. 2, the time resources T1 (e.g., T1-1, T1-2, T1-3) may be selected or determined from a resource pool for the AIoT communication, such as the AIoT resource pool 300 as discussed associated with FIG. 3. The time resources of the resource pool for the AIoT communication are allocated such that the set of uplink time resources T2-1 and T2-2 is refrained from being scheduled for the AIoT link 116. The resource pool for the AIoT communication may indicate a set of uplink frequency resources configured by a RRC (re)configuration message.

In some alternative or additional aspects, as discussed associated with FIG. 4, a periodicity, durations, and/or some other parameters of the time resources T1 (e.g., T1-1, T1-2, T1-3) and the time resources T2 (e.g., T2-1, T2-2) may be configured by a RRC (re)configuration message, and the AIoT communication is triggered by an uplink DCI or a dedicated DCI to indicate or trigger the AIoT communication. As an example, the triggering DCI may include 1 bit information to activate or deactivate the AIoT communication. The triggering DCI may also include indications to only trigger selected frequency/time resources within the RRC configured resources. The triggering DCI may further include other information for transmission, such as transmitting power, etc.

In some further alternative or additional aspects, as discussed associated with FIG. 5, the AIoT communication may be dynamically scheduled by the base station 120, where allocated resources are indicated by an uplink DCI per time unit (e.g., per frame referred by an index). The uplink DCI may indicate starting time and lasting time of the allocated resources, such as a starting slot and a number of lasting slots for communicating the AIoT data as an example. In some aspects, an uplink DCI or a dedicated DCI is used to trigger the AIoT communication. As an example, a single uplink DCI or a single dedicated DCI may include an indicator, such as a dedicated one bit indicator, to indicate whether the scheduled resources is for the D2R data or the R2D data. For example, if the one bit indicator has a value of “0”, the scheduled resources is used to communicate the D2R data, while if the one bit indicator has a value of “1”, the scheduled resources is used to communicate the R2D data.

In some aspects, as shown in FIG. 7B, resources for the D2R communication 116-D2R and the R2D communication 116-R2D are separately allocated in the time domain. The frequency resources for the D2R communication 116-D2R and the R2D communication 116-R2D may be part of the uplink spectrum 103. The D2R communication 116-D2R and the R2D communication 116-R2D may be allocated the same or different frequency resource(s). The D2R communication 116-D2R may be triggered by a previous R2D communication 116-R2D, and the D2R communication 116-D2R and the R2D communication 116-R2D may be scheduled within continuous time resources (an example shown T_{D} and T_{R} within the time resources T1-3) or the D2R communication 116-D2R and the R2D communication 116-R2D may also be arranged in non-continuous resources (an example shown T_{D} and T_{R} between the time resources T1-1 and T1-2). Time intervals (e.g., uplink time resources T2-1 and T2-2) between the non-continuous resources may be the same or different. In the case where a carrier wave 115 is also provided and scheduled by the intermediate node 111, the D2R communication 116-D2R may be or include modulate information on top of the carrier wave 115. The D2R communication 116-D2R may be allocated in the same allocated slots/subframes (an example shown T_{D} and Tc within the time resources T1-1). The carrier wave 115 and the D2R data may be allocated in different symbols in the same allocated slots/subframes. Notably, the time-frequency scheduling patterns within the time resources T1-1, T1-2, and T1-3 are discrete examples provided for illustration purpose may not necessarily concurrently arranged within one scheduling pattern, and other variations of the time-frequency scheduling patterns are also amenable.

In one aspect, as discussed associated with FIGS. 2-3, the time resources T1 (e.g., T1-1, T1-2, T1-3) may be selected or determined from separate pools such as separate D2R resource pool and R2D resource pool including time and/or frequency resources respectively for the D2R communication 116-D2R and the R2D communication 116-R2D. The carrier wave resources may be included in the D2R resource pool, if the carrier wave 115 is transmitted by the intermediate node 111. The D2R resource pool and the R2D resource pool may have identical or different resources configured. The D2R resource pool and R2D resource pool may be configured by a RRC (re)configuration message. The time resources of the D2R resource pool and the R2D resource pool are allocated such that the set of uplink time resources T2-1 and T2-2 is refrained from being scheduled for the D2R communication 116-D2R and the R2D communication 116-R2D.

In some alternative or additional aspects, as discussed associated with FIG. 4, a periodicity, durations, and/or some other parameters of the time resources T1 (e.g., T1-1, T1-2, T1-3) may be configured by a RRC (re)configuration message, and the D2R communication 116-D2R and the R2D communication 116-R2D may be respectively triggered by an uplink DCI or a dedicated DCI to indicate or trigger the AIoT communication.

In some further alternative or additional aspects, as discussed associated with FIG. 5, the AIoT communication may be dynamically scheduled by the base station 120, where allocated resources are indicated by an uplink DCI per time unit (e.g., per frame referred by an index). The uplink DCI may indicate starting time and lasting time of the allocated resources, such as a starting slot and a number of lasting slots for communicating the D2R data or the R2D data as an example. In some aspects, an uplink DCI or a dedicated DCI is used to schedule the D2R communication 116-D2R or the R2D communication 116-R2D. As an example, a first uplink or dedicated DCI is used to schedule the D2R communication 116-D2R. The first uplink or dedicated DCI may indicate starting time and lasting time of the allocated resources, such as a starting slot and a number of lasting slots for the D2R communication 116-D2R. A second uplink or dedicated DCI is used to schedule the R2D communication 116-R2D. The second uplink or dedicated DCI may indicate starting time and lasting time of the allocated resources, such as a starting slot and a number of lasting slots for the The first uplink or dedicated DCI may indicate starting time and lasting time of the allocated resources, such as a starting slot and a number of lasting slots for the D2R communication 116-D2R.

Further, the carrier wave 115 may be provided to the AIoT device 112 by a CW node 113 as shown in Fig. A or the intermediate node 111 as shown in FIG. 7A. When the carrier wave 115 is provided by the CW node 113 (FIG. 6A), the scheduling restrictions to the uplink spectrum 114-U does not apply to the carrier wave 115. When the carrier wave 115 is provided by the intermediate node 111 (FIG. 7A), the carrier wave 115 may also be arranged on the uplink spectrum 103 (example shown in FIG. 7B), and the corresponding scheduling restrictions to the uplink spectrum 114-U may also apply to the carrier wave 115 as examples provided above.

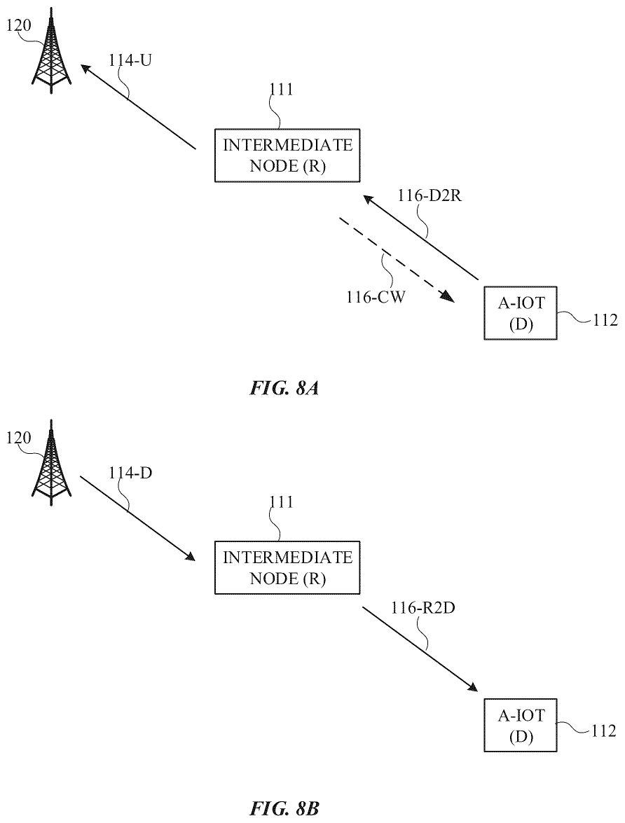

FIGS. 8A-8B and 9-10 are schematic diagrams illustrating resource allocation of AIoT communication on respective uplink and downlink resources in accordance with some aspects of the present disclosure. In some aspects, as shown in FIG. 8A, the D2R communication 116-D2R uses uplink resources in an uplink spectrum of an access link which causes a cross-link interference to the D2R communication 116-D2R by the uplink communication 114-U. As shown in FIG. 8B, the R2D communication 116-R2D uses downlink resources in a downlink spectrum of the access link which causes a cross-link interference to the R2D communication 116-R2D by the downlink communication 114-D between the intermediate node 111 and the base station 120. In order to mitigate the cross-link interferences, the scheduling restriction may be placed on the uplink communication 114-U when performing the D2R communication 116-D2R and placed on the downlink communication 114-D when performing the R2D communication 116-R2D.

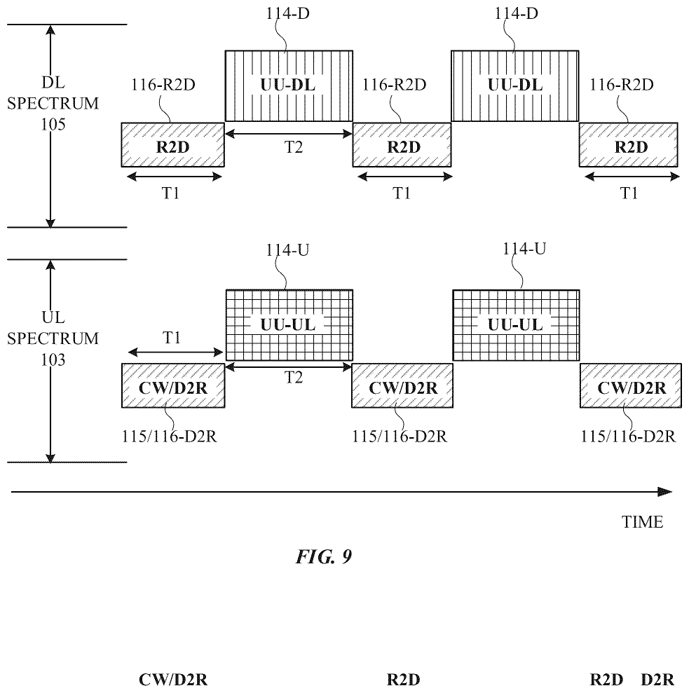

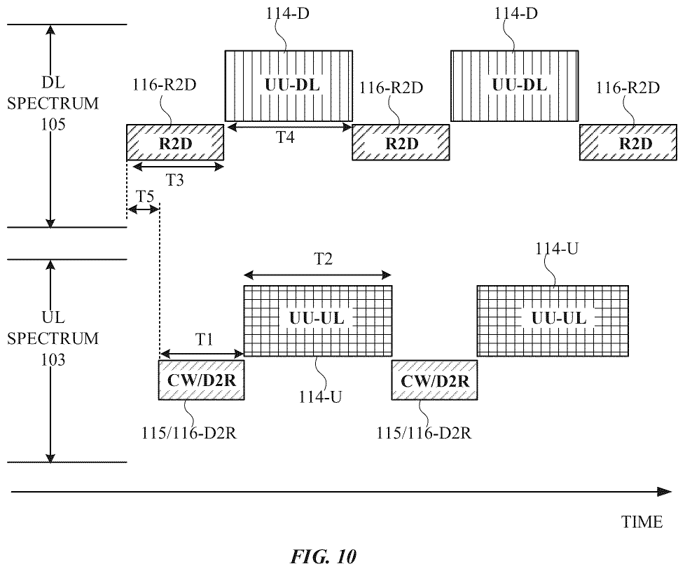

As shown in FIG. 9 and FIG. 10, in some aspects, in case of paired uplink spectrum 103 and downlink spectrum 105 of a FDD band, a set of uplink frequency resources on the uplink spectrum 103 is allocated for the D2R communication 116-D2R. A set of downlink frequency resources on the downlink spectrum 105 is allocated for the R2D communication 116-R2D. The scheduling restriction may be respectively placed on the uplink communication 114-U and the downlink communication 114-D of the intermediate node 111. In some aspects of the scheduling restriction already discussed, the set of time resources for the D2R communication 116-D2R is not overlapped with the scheduled uplink communication 114-U, and the set of time resources for the R2D communication 116-R2D is not overlapped with the scheduled downlink communication 114-D.

Further, though not shown in the figures, in some aspects, a time gap may be further defined and required to separate the AIoT communication and the access link communication. Specifically, a first time gap may be required between the D2R communication 116-D2R and the uplink communication 114-U. A second time gap may be required between the R2D communication 116-R2D and the downlink communication 114-D. The first time gap and the second time gap may be identical or different. In some further embodiments, the time gaps may be negative values, which means that a limited overlap may be tolerable, still under the principle that the time resources for AIoT communication should be refrained from scheduling corresponding access link communication. In this way, a balance may be better achieved for both resource efficiency and data liability. In an application, the time gaps may be indicated in a time unit, such as symbols.

As shown in FIG. 9, when a first set of time resources (e.g., represented by T1) is scheduled for the AIoT link 116 including the R2D communication 116-R2D and the D2R communication 116-D2R (e.g. by configured an AIoT resource pool and/or selecting resources from the AIoT resource pool as discussed above), the first set of time resources (e.g., represented by T1) may be TDMed with a second set of time resources (e.g., represented by T2) that are scheduled for access link transmission including the uplink communication 114-U and the downlink communication 114-D.

As shown in FIG. 10, a first set of time resources (e.g., represented by T1) may be scheduled for the D2R communication 116-D2R (and the communication of the CW 115 if provided by the intermediate node 111). The first set of time resources (e.g., represented by T1) may be configured by an RRC message and/or selected from a D2R resource pool or dynamically scheduled by an uplink DCI. A second set of time resources (e.g., represented by T2) may are scheduled for the uplink communication 114-U. The first set of time resources (e.g., represented by T1) and the second set of time resources (e.g., represented by T2) may be avoided from overlapping, or TDMed, or separated by a required time gap (including a negative time gap). In some aspects, the first set of time resources is scheduled by a periodic configuration, a configured grant triggered by an uplink DCI for a periodicity configured by a RRC message, or a dynamical scheduling indicated by an uplink DCI with a different identity. The uplink DCI may indicate starting and lasting time of the first set of time resources for the D2R communication 116-D2R (and the communication of the carrier wave 115 if provided by the intermediate node 111).

Similarly, a third set of time resources (e.g., represented by T3) may be scheduled for the R2D communication 116-R2D. The third set of time resources (e.g., represented by T3) may be configured by an RRC message and/or selected from an R2D resource pool or dynamically scheduled by a downlink DCI. A fourth set of time resources (e.g., represented by T4) may are scheduled for the downlink communication 114-D. The third set of time resources (e.g., represented by T3) and the fourth set of time resources (e.g., represented by T4) may be avoided from overlapping, or TDMed, or separated by a required time gap (including a negative time gap). In some aspects, the third set of time resources is scheduled by a periodic configuration, a configured grant triggered by a downlink DCI for a periodicity configured by a RRC message, or a dynamical scheduling indicated by a downlink DCI with a different identity. The downlink DCI may indicate starting and lasting time of the third set of time resources for the R2D communication 116-R2D. A time offset T5 may be configured or otherwise scheduled between the first set of time resources T1 and the third set of time resources T3.

In some aspects, a single DCI is used to indicate or trigger both the D2R communication 116-D2R and the R2D communication 116-R2D. The single DCI may be an uplink DCI, a downlink DCI, or a dedicated DCI. The single DCI may include an indicator indicating whether the scheduled resources is for the D2R communication 116-D2R and/or the R2D communication 116-R2D.

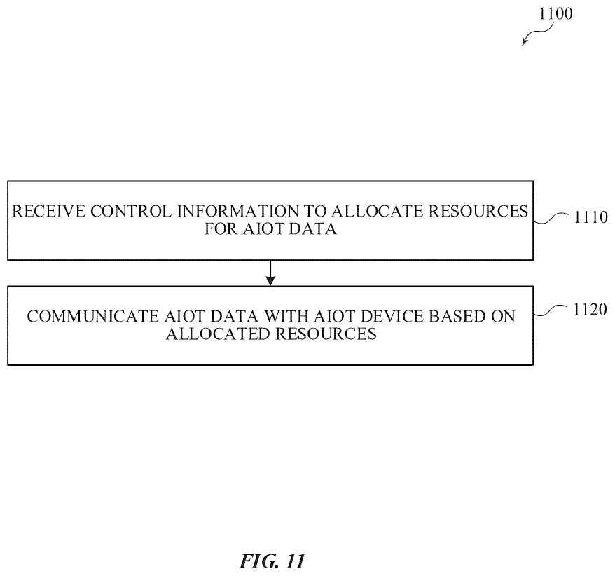

FIG. 11 is a process flow for an intermediate node to communicate AIoT data in accordance with some aspects. The process flow illustrated by FIG. 11 may implement techniques described throughout the present disclosure, for example, as described with reference to FIGS. 1-10 above.

At act 1110, the intermediate node receives control information from the base station to allocate resources for AIoT communication between the intermediate node and an AIoT device. The allocated time resources may not be scheduled for an access link communication with the base station, such that a cross-link interference can be mitigated. Specifically, in some aspects, the allocated time resources may be non-overlapping or TDMed with an uplink transmission with the base station, if both D2R data and R2D data are allocated in a corresponding uplink spectrum. In some alternative aspects, a first set of time resources allocated to D2R data may be non-overlapping or TDMed with an uplink transmission with the base station, and a second set of time resources allocated to R2D data may be non-overlapping or TDMed with a downlink transmission with the base station if the D2R data is allocated in a corresponding uplink spectrum while the R2D data is allocated in a corresponding downlink spectrum.

In some aspects, the control information is included in a RRC message that configures AIoT resource pools, schedules periodic time resources, and/or schedules frequency resources for AIoT communication. The control information may also comprise triggering command DCI that activates or deactivates the communication of the AIoT data or further indicates scheduled resources for the AIoT communication. Two separate DCIs may be used respectively for the D2R data receiving and R2D data transmission.

At act 1120, the intermediate node performs the AIoT communication with the AIoT device based on the allocated resources. The intermediate node also performs the access link communication with the base station based on scheduling signaling received from the base station. In some aspects, the time resources allocated for AIoT communication is non-overlapping with the uplink transmission. The access link communication between the intermediate node and the base station may be TDMed with the AIoT communication.

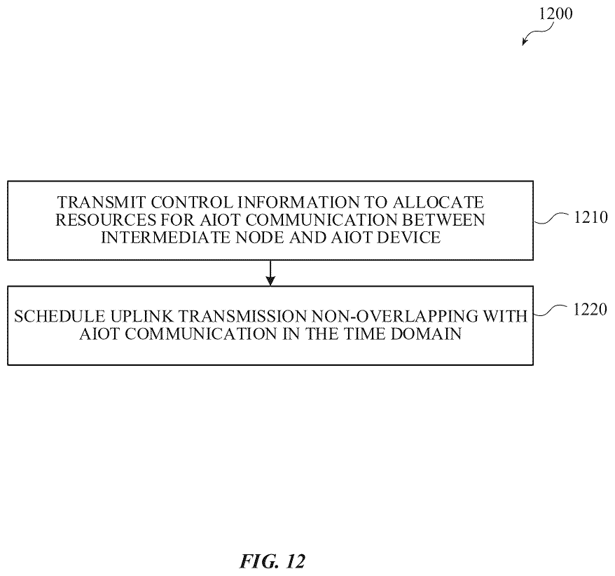

FIG. 12 is a process flow for a base station to schedule AIoT communication in accordance with some aspects. The process flow illustrated by FIG. 12 may implement techniques described throughout the present disclosure, for example, as described with reference to FIGS. 1-11 above. At act 1210, the base station transmits control information to allocate resources for AIoT communication between the intermediate node and an AIoT device. At act 1220, the base station schedules an access link communication with the intermediate node. In some aspects, an uplink transmission is scheduled non-overlapping with the AIoT communication in the time domain.

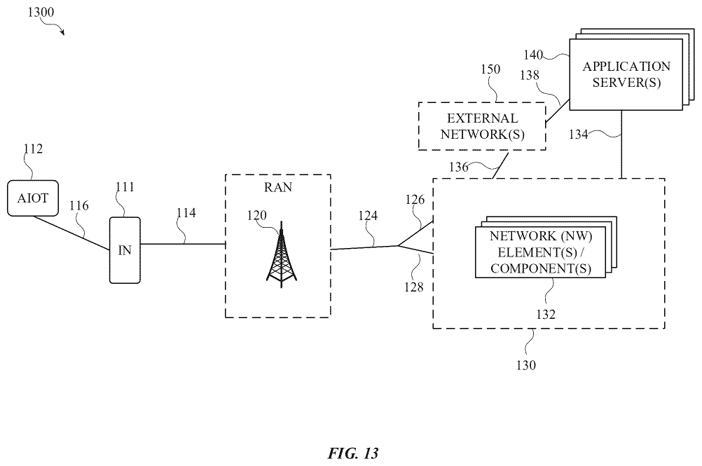

FIG. 13 is an example network 1300 according to one or more implementations described herein. Example network 1300 may include an AIoT device 112, an intermediate node 111, a base station 120, a core network 130, an application server 140, and an external network 150.

The systems and devices of example network 1300 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 1300 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

The intermediate node 111 may be a relay device, an integrated access and backhaul (IAB) node, a user equipment (UE), a repeater, etc. Examples of the intermediate node 111 may include mobile or non-mobile computing devices connectable to one or more wireless communication networks, such as phones, TVs, smart speakers, doorbells, cars, or appliances. Additionally or alternatively, the intermediate node 111 may include other types of mobile or non-mobile computing devices capable of wireless communications, such as personal data assistants (PDAs), pagers, laptop computers, desktop computers, wireless handsets, etc. The intermediate node 111 is configured to perform bidirectional communication with a base station 120 over an access link 114 and perform bidirectional communication with an AIoT device 112 over the AIoT link 116. The intermediate node 111 serves as an AIoT reader for the AIoT device 112. The AIoT device 112 may be selective objects having a digital identity, connectivity and intelligence. Examples of the AIoT device 112 may include consumer merchants, such as food, medicine, clothing, luggage, and documents or other industrial applications.

The intermediate node 111 may establish a connection with (e.g., be communicatively coupled) and communicate with RAN, which may involve one or more wireless channels for a access link 114, each of the wireless channels may comprise a physical communications interface/layer. In some implementations, the intermediate node 111 may be configured with dual connectivity (DC) as a multi-radio access technology (multi-RAT) or multi-radio dual connectivity (MR-DC), where a multiple receive and transmit (Rx/Tx) capable UE may use resources provided by different network nodes that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 130. Additionally, at least one of the MN or the SN may be operated with shared spectrum channel access. In some implementations, a base station (as described herein) may be an example of network node or an exchangeable term of network node or network node.

RAN may include one or more base station 120 that enables the access link 114 to be established with intermediate node 111. The base station 120 may include network access points configured to provide radio baseband functions for data and/or voice connectivity between users and the network based on one or more of the communication technologies described herein (e.g., 2G, 3G, 4G, 5G, WiFi, etc.). As examples therefore, the base station 120 may be an E-UTRAN Node B (e.g., an enhanced Node B, eNodeB, eNB, 4G base station, etc.), a next generation base station (e.g., a 5G base station, NR base station, next generation eNBs (gNB), etc.). base station 120 may include a roadside unit (RSU), a transmission reception point (TRxP or TRP), and one or more other types of ground stations (e.g., terrestrial access points). In some scenarios, base station 120 may be a dedicated physical device, such as a macrocell base station, and/or a low power (LP) base station for providing femtocells, picocells or other like having smaller coverage areas, smaller user capacity, or higher bandwidth compared to macrocells. References herein to a base station, base station 120, etc., may involve implementations where the base station, base station 120, etc., is a terrestrial network node and also to implementation where the base station, base station 120, etc., is a non-terrestrial network node (e.g., satellite).

Some or all of base station 120 may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual base station 120; a media access control (MAC)/physical (PHY) layer split wherein RRC, PDCP, radio link control (RLC), and MAC layers may be operated by the CRAN/vBBUP and the PHY layer may be operated by individual base station 120; or a “lower PHY” split wherein RRC, PDCP, RLC, MAC layers and upper portions of the PHY layer may be operated by the CRAN/vBBUP and lower portions of the PHY layer may be operated by individual base station 120. This virtualized framework may allow freed-up processor cores of base station 120 to perform or execute other virtualized applications.

In some implementations, an individual base station 120 may represent individual gNB-distributed units (DUs) connected to a gNB-control unit (CU) via individual F1 interfaces. In such implementations, the gNB-DUs may include one or more remote radio heads or radio frequency (RF) front end modules (RFEMs), and the gNB-CU may be operated by a server (not shown) located in RAN or by a server pool (e.g., a group of servers configured to share resources) in a similar manner as the CRAN/vBBUP. Additionally, or alternatively, one or more of base station 120 may be next generation eNBs (i.e., gNBs) that may provide evolved universal terrestrial radio access (E-UTRA) user plane and control plane protocol terminations toward intermediate node 111, and that may be connected to a 5G core network (5GC) 130 via an NG interface.

Any of the base station 120 may terminate an air interface protocol and may be the first point of contact for intermediate node 111. In some implementations, any of the base station 120 may fulfill various logical functions for the RAN including, but not limited to, radio network controller (RNC) functions such as radio bearer management, uplink and downlink dynamic radio resource management and data packet scheduling, and mobility management. intermediate node 111 may be configured to communicate using orthogonal frequency-division multiplexing (OFDM) communication signals with each other or with any of the base station 120 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

As shown, the base station 120 may be connected (e.g., communicatively coupled) to the CN 130. The CN 130 may comprise a plurality of network elements 132, which are configured to offer various data and telecommunications services to customers/subscribers (e.g., users of intermediate node 111) who are connected to the core network 130 via the RAN. In some implementations, the core network 130 may include an evolved packet core (EPC), a 5G CN, and/or one or more additional or alternative types of CNs. The components of the CN 130 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 130 may be referred to as a network slice, and a logical instantiation of a portion of the CN 130 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, the core network 130, the application servers 140, and external networks 150 may be connected to one another via interfaces 134, 136, and 138, which may include IP network interfaces. Application servers 140 may include one or more server devices or network elements (e.g., virtual network functions (VNFs) offering applications that use IP bearer resources with the CN 130 (e.g., universal mobile telecommunications system packet services (UMTS PS) domain, LTE PS data services, etc.). Application servers 140 may also, or alternatively, be configured to support one or more communication services (e.g., voice over IP (VOIP sessions, push-to-talk (PTT) sessions, group communication sessions, social networking services, etc.) for intermediate node 111 via the CN 130. Similarly, external networks 150 may include one or more of a variety of networks, including the Internet, thereby providing the mobile communication network and intermediate node 111 of the network access to a variety of additional services, information, interconnectivity, and other network features.

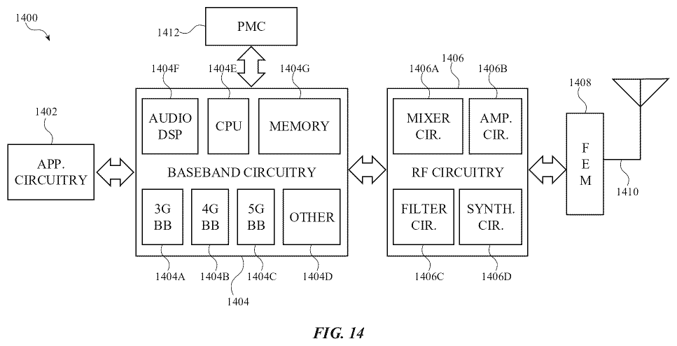

FIG. 14 is a diagram of an example of components of a device according to one or more implementations described herein. In some implementations, the device 1400 can include application circuitry 1402, baseband circuitry 1404, RF circuitry 1406, front-end module (FEM) circuitry 1408, one or more antennas 1410, and power management circuitry (PMC) 1412 coupled together at least as shown. The components of the illustrated device 1400 can be or be included in the intermediate node 111 as described throughout the specification. In some implementations, the device 1400 can include fewer elements (e.g., a RAN node may not utilize application circuitry 1402, and instead include a processor/controller to process IP data received from a CN such as a 5GC or an Evolved Packet Core (EPC)). In some implementations, the device 1400 can include additional elements such as, for example, memory/storage, display, camera, sensor (including one or more temperature sensors, such as a single temperature sensor, a plurality of temperature sensors at different locations in device 1400, etc.), or input/output (I/O) interface. In other implementations, the components described below can be included in more than one device (e.g., said circuitries can be separately included in more than one device for Cloud-RAN (C-RAN) implementations).

The application circuitry 1402 can include one or more application processors. For example, the application circuitry 1402 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1400. In some implementations, processors of application circuitry 1402 can process IP data packets received from an EPC.

The baseband circuitry 1404 can include circuitry such as, but not limited to, one or more single-core or multi-core processors. The baseband circuitry 1404 can include one or more baseband processors or control logic to process baseband signals received from a receive signal path of the RF circuitry 1406 and to generate baseband signals for a transmit signal path of the RF circuitry 1406. Baseband circuitry 1404 can interface with the application circuitry 1402 for generation and processing of the baseband signals and for controlling operations of the RF circuitry 1406. For example, in some implementations, the baseband circuitry 1404 can include a 3G baseband processor 1404A, a 4G baseband processor 1404B, a 5G baseband processor 1404C, or other baseband processor(s) 1404D for other existing generations, generations in development or to be developed in the future (e.g., 2G, 6G, etc.). The baseband circuitry 1404 (e.g., one or more of baseband processors 1404A-D) can handle various radio control functions that enable communication with one or more radio networks via the RF circuitry 1406. In other implementations, some or all of the functionality of baseband processors 1404A-D can be included in modules stored in the memory 1404G and executed via a Central Processing Unit (CPU) 1404E. The radio control functions can include, but are not limited to, signal modulation/demodulation, encoding/decoding, radio frequency shifting, etc. In some implementations, modulation/demodulation circuitry of the baseband circuitry 1404 can include Fast-Fourier Transform (FFT), precoding, or constellation mapping/de-mapping functionality. In some implementations, encoding/decoding circuitry of the baseband circuitry 1404 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, the baseband circuitry 1404 can include one or more audio digital signal processor(s) (DSP) 1404F. The audio DSPs 1404F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1404 and the application circuitry 1402 can be implemented together such as, for example, on a system on a chip (SOC).

In some implementations, the baseband circuitry 1404 can provide for communication compatible with one or more radio technologies. For example, in some implementations, the baseband circuitry 1404 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1404 is configured to support radio communications of more than one wireless protocol can be referred to as multi-mode baseband circuitry.

RF circuitry 1406 can enable communication with wireless networks using modulated electromagnetic radiation through a non-solid medium. In various implementations, the RF circuitry 1406 can include switches, filters, amplifiers, etc. to facilitate the communication with the wireless network. RF circuitry 1406 can include a receive signal path which can include circuitry to down-convert RF signals received from the FEM circuitry 1408 and provide baseband signals to the baseband circuitry 1404. RF circuitry 1406 can also include a transmit signal path which can include circuitry to up-convert baseband signals provided by the baseband circuitry 1404 and provide RF output signals to the FEM circuitry 1408 for transmission.

In some implementations, the receive signal path of the RF circuitry 1406 can include mixer circuitry 1406A, amplifier circuitry 1406B and filter circuitry 1406C. In some implementations, the transmit signal path of the RF circuitry 1406 can include filter circuitry 1406C and mixer circuitry 1406A. RF circuitry 1406 can also include synthesizer circuitry 1406D for synthesizing a frequency for use by the mixer circuitry 1406A of the receive signal path and the transmit signal path. In some implementations, the mixer circuitry 1406A of the receive signal path can be configured to down-convert RF signals received from the FEM circuitry 1408 based on the synthesized frequency provided by synthesizer circuitry 1406D. The amplifier circuitry 1406B can be configured to amplify the down-converted signals and the filter circuitry 1406C can be a low-pass filter (LPF) or band-pass filter (BPF) configured to remove unwanted signals from the down-converted signals to generate output baseband signals. Output baseband signals can be provided to the baseband circuitry 1404 for further processing. In some implementations, the output baseband signals can be zero-frequency baseband signals, although this is not a requirement. In some implementations, mixer circuitry 1406A of the receive signal path can comprise passive mixers, although the scope of the implementations is not limited in this respect.

In some implementations, the mixer circuitry 1406A of the transmit signal path can be configured to up-convert input baseband signals based on the synthesized frequency provided by the synthesizer circuitry 1406D to generate RF output signals for the FEM circuitry 1408. The baseband signals can be provided by the baseband circuitry 1404 and can be filtered by filter circuitry 1406C.

In some implementations, the mixer circuitry 1406A of the receive signal path and the mixer circuitry 1406A of the transmit signal path can include two or more mixers and can be arranged for quadrature down conversion and up conversion, respectively. In some implementations, the mixer circuitry 1406A of the receive signal path and the mixer circuitry 1406A of the transmit signal path can include two or more mixers and can be arranged for image rejection (e.g., Hartley image rejection). In some implementations, the mixer circuitry 1406A of the receive signal path and the mixer circuitry 1406A can be arranged for direct down conversion and direct up conversion, respectively. In some implementations, the mixer circuitry 1406A of the receive signal path and the mixer circuitry 1406A of the transmit signal path can be configured for super-heterodyne operation.

In some implementations, the output baseband signals, and the input baseband signals, can be analog baseband signals, although the scope of the implementations is not limited in this respect. In some alternate implementations, the output baseband signals, and the input baseband signals, can be digital baseband signals. In these alternate implementations, the RF circuitry 1406 can include analog-to-digital converter (ADC) and digital-to-analog converter (DAC) circuitry and the baseband circuitry 1404 can include a digital baseband interface to communicate with the RF circuitry 1406.

In some dual-mode implementations, a separate radio IC circuitry can be provided for processing signals for each spectrum, although the scope of the implementations is not limited in this respect.

In some implementations, the synthesizer circuitry 1406D can be a fractional-N synthesizer or a fractional N/N+1 synthesizer, although the scope of the implementations is not limited in this respect as other types of frequency synthesizers can be suitable. For example, synthesizer circuitry 1406D can be a delta-sigma synthesizer, a frequency multiplier, or a synthesizer comprising a phase-locked loop with a frequency divider.

The synthesizer circuitry 1406D can be configured to synthesize an output frequency for use by the mixer circuitry 1406A of the RF circuitry 1406 based on a frequency input and a divider control input. In some implementations, the synthesizer circuitry 1406D can be a fractional N/N+1 synthesizer.

In some implementations, frequency input can be provided by a voltage-controlled oscillator (VCO), although that is not a requirement. Divider control input can be provided by either the baseband circuitry 1404 or the applications circuitry 1402 depending on the desired output frequency. In some implementations, a divider control input (e.g., N) can be determined from a look-up table based on a channel indicated by the applications circuitry 1402.

Synthesizer circuitry 1406D of the RF circuitry 1406 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1406D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1406 can include an IQ/polar converter.

FEM circuitry 1408 can include a receive signal path which can include circuitry configured to operate on RF signals received from one or more antennas 1410, amplify the received signals and provide the amplified versions of the received signals to the RF circuitry 1406 for further processing. FEM circuitry 1408 can also include a transmit signal path which can include circuitry configured to amplify signals for transmission provided by the RF circuitry 1406 for transmission by one or more of the one or more antennas 1410. In various implementations, the amplification through the transmit or receive signal paths can be done solely in the RF circuitry 1406, solely in the FEM circuitry 1408, or in both the RF circuitry 1406 and the FEM circuitry 1408.

In some implementations, the FEM circuitry 1408 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1406). The transmit signal path of the FEM circuitry 1408 can include a power amplifier (PA) to amplify input RF signals (e.g., provided by RF circuitry 1406), and one or more filters to generate RF signals for subsequent transmission (e.g., by one or more of the one or more antennas 1410).

In some implementations, the PMC 1412 can manage power provided to the baseband circuitry 1404. In particular, the PMC 1412 can control power-source selection, voltage scaling, battery charging, or DC-to-DC conversion. The PMC 1412 can often be included when the device 1400 is capable of being powered by a battery, for example, when the device is included in a UE. The PMC 1412 can increase the power conversion efficiency while providing desirable implementation size and heat dissipation characteristics.

While FIG. 14 shows the PMC 1412 coupled only with the baseband circuitry 1404. However, in other implementations, the PMC 1412 may be additionally or alternatively coupled with, and perform similar power management operations for, other components such as, but not limited to, application circuitry 1402, RF circuitry 1406, or FEM circuitry 1408.

In some implementations, the PMC 1412 can control, or otherwise be part of, various power saving mechanisms of the device 1400. For example, if the device 1400 is in an RRC_Connected state, where it is still connected to the RAN node as it expects to receive traffic shortly, then it can enter a state known as Discontinuous Reception Mode (DRX) after a period of inactivity. During this state, the device 1400 can power down for brief intervals of time and thus save power.

If there is no data traffic activity for an extended period of time, then the device 1400 can transition off to an RRC_Idle state, where it disconnects from the network and does not perform operations such as channel quality feedback, handover, etc. The device 1400 goes into a very low power state and it performs paging where again it periodically wakes up to listen to the network and then powers down again. The device 1400 may not receive data in this state; to receive data, it can transition back to RRC_Connected state.

An additional power saving mode can allow a device to be unavailable to the network for periods longer than a paging interval (ranging from seconds to a few hours). During this time, the device is totally unreachable to the network and can power down completely. Any data sent during this time incurs a large delay and it is assumed the delay is acceptable.

Processors of the application circuitry 1402 and processors of the baseband circuitry 1404 can be used to execute elements of one or more instances of a protocol stack. For example, processors of the baseband circuitry 1404, alone or in combination, can be used execute Layer 3, Layer 2, or Layer 1 functionality, while processors of the baseband circuitry 1404 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

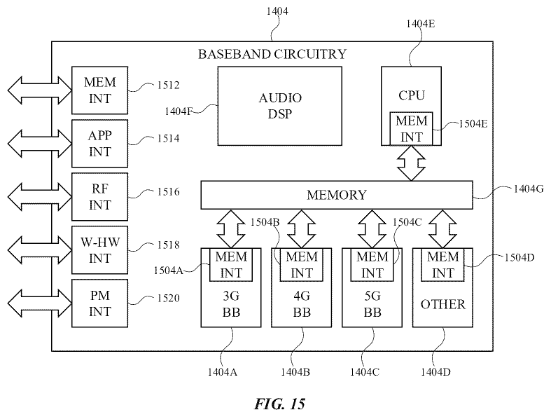

FIG. 15 is a diagram of example interfaces of baseband circuitry according to one or more implementations described herein. As discussed above, the baseband circuitry 1404 of FIG. 14 can comprise processors 1404A-1404E and a memory 1404G utilized by said processors. Each of the processors 1404A-1404E can include a memory interface, 1504A-1504E, respectively, to send/receive data to/from the memory 1404G.

The baseband circuitry 1404 can further include one or more interfaces to communicatively couple to other circuitries/devices, such as a memory interface 1512 (e.g., an interface to send/receive data to/from memory external to the baseband circuitry 1404), an application circuitry interface 1514 (e.g., an interface to send/receive data to/from the application circuitry 1402 of FIG. 14), an RF circuitry interface 1516 (e.g., an interface to send/receive data to/from RF circuitry 1406 of FIG. 14), a wireless hardware connectivity interface 1518 (e.g., an interface to send/receive data to/from Near Field Communication (NFC) components, Bluetooth components, Wi-Fi components, and other communication components), and a power management interface 1520 (e.g., an interface to send/receive power or control signals to/from the PMC 1412).

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

Example 1 is a baseband processor for an intermediate node connecting an AIoT device and a base station. When executing instructions stored in a memory coupled to the baseband processor, the baseband processor is configured to decode control information received from the base station to schedule a first set of time resources for AIoT data and encode or decode the AIoT data for communicating with the AIoT device using the first set of time resources. The first set of time resources is not scheduled for uplink transmission to the base station. Example 2 includes the subject matter of example 1, including or omitting optional elements, wherein the control information is included in a radio resource control (RRC) message that schedules the first set of time resources periodically and also frequency resources for the communication of the AIoT data.

Example 3 includes the subject matter of example 1, including or omitting optional elements, wherein the decoding of the control information comprises decoding a radio resource control (RRC) message received from the base station, wherein the RRC message configures an AIoT resource pool for communicating the AIoT data, and decoding downlink control information (DCI) that activates or deactivates the communication of the AIoT data.

Example 4 includes the subject matter of example 1, including or omitting optional elements, wherein the decoding of the control information comprises decoding a radio resource control (RRC) message received from the base station, wherein the RRC message configures an AIoT resource pool for communicating the AIoT data, decoding a first downlink control information (DCI) that activates or deactivates D2R data of the AIoT data to be received from the AIoT device, and decoding a second downlink control information (DCI) that activates or deactivates R2D data of the AIoT data to be transmitted to the AIoT device.

Example 5 includes the subject matter of example 1, including or omitting optional elements, wherein the control information is included in downlink control information (DCI) that indicates starting and lasting time of the first set of time resources.

Example 6 includes the subject matter of example 1, including or omitting optional elements, wherein the control information indicates the first set of time resources by indicating a starting slot and a number of lasting slots for communicating the AIoT data.

Example 7 includes the subject matter of example 1, including or omitting optional elements, wherein a set of uplink frequency resources is allocated for D2R data of the AIoT data received from the AIoT device, and wherein a set of downlink frequency resources is allocated for R2D data of the AIoT data transmitted to the AIoT device.

Example 8 includes the subject matter of example 7, including or omitting optional elements, wherein the set of uplink frequency resources and the set of downlink frequency resources are configured by a radio resource control (RRC) message.

Example 9 includes the subject matter of example 8, including or omitting optional elements, further configured to decode the RRC message received from the base station; decode a downlink control information (DCI) that activates or deactivates the communication of the AIoT data; and upon decoding the DCI, determine to receive the D2R data or to transmit the R2D data on the first set of time resources.

Example 10 includes the subject matter of example 1, including or omitting optional elements, 7, further configured to: in response to decoding an uplink downlink control information (DCI), decode the D2R data based on the uplink DCI, and in response to decoding a downlink DCI, encode the R2D data for transmission based on the downlink DCI.

Example 11 includes the subject matter of example 1, including or omitting optional elements, wherein the first set of time resources is scheduled for receiving D2R data of the AIoT data from the AIoT device, and wherein a second set of time resources is scheduled for transmitting R2D data of the AIoT data to the AIoT device, the second set of time resources is scheduled avoiding downlink receiving from the base station.

Example 12 includes the subject matter of example 11, including or omitting optional elements, wherein the first set of time resources and the second set of time resources are respectively included in a D2R resource pool and a R2D resource pool configured by a radio resource control (RRC) message.

Example 13 includes the subject matter of example 1, including or omitting optional elements, wherein a set of uplink frequency resources is allocated for both D2R data of the AIoT data received from the AIoT device and R2D data of the AIoT data transmitted to the AIoT device.

Example 14 includes the subject matter of example 1, including or omitting optional elements, wherein the first set of time resources is scheduled for the communication of the AIoT data including transmitting a carrier wave for the AIoT device.

Example 15 is a method performed by a base station, comprising transmitting, to an intermediate node, control information to schedule a set of time resources for communicating AIoT data, the AIoT data including D2R data transmitted from an Ambient Internet of Things (AIoT) device to the intermediate node and R2D data transmitted from the intermediate node to the AIoT device; and scheduling an uplink transmission from the intermediate node non-overlapping with the set of time resources.

Example 16 includes the subject matter of example 1, including or omitting optional elements, wherein a set of uplink frequency resources is configured for both the D2R data and the R2D data.

Example 17 includes the subject matter of example 1, including or omitting optional elements, wherein a set of uplink frequency resources is allocated for the D2R data, and a set of downlink frequency resources is allocated for the R2D data.

Example 18 includes the subject matter of example 1, including or omitting optional elements, wherein the transmitting of the control information comprising transmitting, to the intermediate node, a radio resource control (RRC) message that configures a D2R resource pool for the D2R data and a R2D resource pool for the R2D data; and transmitting downlink control information (DCI) that activates or deactivates the intermediate node receiving the D2R data or transmitting the R2D data.

Example 19 includes the subject matter of example 1, including or omitting optional elements, wherein the transmitting of the control information comprising transmitting, to the intermediate node, a first downlink control information (DCI) that indicates starting and lasting number of slots for the AIoT device to receive the D2R data; and transmitting, to the intermediate node, a second DCI that indicates starting and lasting number of slots for the AIoT device to transmit the R2D data.

Example 20 is an apparatus, acting as an intermediate node to connect an ambient Internet of Things (AIoT) device and a base station, when executing instructions stored in a memory, configured to perform operations comprising receiving, from the base station, control information to allocate resources for AIoT communication; and performing the AIoT communication with the AIoT device based on the allocated resources. Wherein the resources are allocated where an access link transmission between the intermediate node and the base station is time division multiplexed (TDMed) with the AIoT communication.

Example 21 is an apparatus that includes means for performing functions corresponding to the operations performed by the baseband processor or one or more processors or devices of examples 1-14 and 20.

Example 21 is a method that includes functions corresponding to the operations performed by the baseband processor or one or more processors of examples 1-14 and 20.

Example 23 is an apparatus of an intermediate node including the baseband processor of examples 1-14 and 20.

Example 24 is an apparatus that includes means for performing functions corresponding to the operations performed by the baseband processor or one or more processors or methods of examples 1-20.

Example 25 is an apparatus configured to perform the methods of examples 15-19.

Example 26 is a method that includes any action or combination of actions as substantially described herein in the Detailed Description.

Example 27 is a method as substantially described herein with reference to each or any combination of the Figures included herein or with reference to each or any combination of paragraphs in the Detailed Description.

Example 28 is an apparatus configured to perform any action or combination of actions as substantially described herein in the Detailed Description as included in the user equipment.

Example 29 is a network node configured to perform any action or combination of actions as substantially described herein in the Detailed Description as included in the network node.

Example 30 is a non-volatile computer-readable medium that stores instructions that, when executed, cause the performance of any action or combination of actions as substantially described herein in the Detailed Description.

Example 31 is a baseband processor of an intermediate node configured to perform any action or combination of actions as substantially described herein in the Detailed Description as included in the user equipment.

Example 32 is a baseband processor of a network node configured to perform any action or combination of actions as substantially described herein in the Detailed Description as included in the user equipment.

Other examples may include a method (e.g., a process) and/or a computer-readable medium implementation of any of the foregoing examples or combinations thereof. The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given, or particular, application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A baseband processor, for an intermediate node connecting an Ambient Internet of Things (AIoT) device and a base station, when executing instructions stored in a memory coupled to the baseband processor, configured to:
decode control information received from the base station to schedule a first set of time resources for AIoT data; and
encode or decode the AIoT data for communicating with the AIoT device using the first set of time resources,
wherein the first set of time resources is not scheduled for uplink transmission to the base station.

2. The baseband processor of claim 1, wherein the control information is included in a radio resource control (RRC) message that schedules the first set of time resources periodically and also frequency resources for the communication of the AIoT data.

3. The baseband processor of claim 1, wherein the decoding of the control information comprises:
decoding a radio resource control (RRC) message received from the base station, wherein the RRC message configures an AIoT resource pool for communicating the AIoT data, and
decoding downlink control information (DCI) that activates or deactivates the communication of the AIoT data.

4. The baseband processor of claim 1, wherein the decoding of the control information comprises:
decoding a radio resource control (RRC) message received from the base station, wherein the RRC message configures an AIoT resource pool for communicating the AIoT data, decoding a first downlink control information (DCI) that activates or deactivates D2R data of the AIoT data to be received from the AIoT device, and
decoding a second downlink control information (DCI) that activates or deactivates R2D data of the AIoT data to be transmitted to the AIoT device.

5. The baseband processor of claim 1, wherein the control information is included in downlink control information (DCI) that indicates starting and lasting time of the first set of time resources.

6. The baseband processor of claim 1, wherein the control information indicates the first set of time resources by indicating a starting slot and a number of lasting slots for communicating the AIoT data.

7. The baseband processor of claim 1,
wherein a set of uplink frequency resources is allocated for D2R data of the AIoT data received from the AIoT device, and
wherein a set of downlink frequency resources is allocated for R2D data of the AIoT data transmitted to the AIoT device.

8. The baseband processor of claim 7, wherein the set of uplink frequency resources and the set of downlink frequency resources are configured by a radio resource control (RRC) message.

9. The baseband processor of claim 8, further configured to:
decode the RRC message received from the base station;
decode a downlink control information (DCI) that activates or deactivates the communication of the AIoT data; and
upon decoding the DCI, determine to receive the D2R data or to transmit the R2D data on the first set of time resources.

10. The baseband processor of claim 7, further configured to:
in response to decoding an uplink downlink control information (DCI), decode the D2R data based on the uplink DCI, and
in response to decoding a downlink DCI, encode the R2D data for transmission based on the downlink DCI.

11. The baseband processor of claim 1,
wherein the first set of time resources is scheduled for receiving D2R data of the AIoT data from the AIoT device, and
wherein a second set of time resources is scheduled for transmitting R2D data of the AIoT data to the AIoT device, the second set of time resources is scheduled avoiding downlink receiving from the base station.

12. The baseband processor of claim 11, wherein the first set of time resources and the second set of time resources are respectively included in a D2R resource pool and a R2D resource pool configured by a radio resource control (RRC) message.

13. The baseband processor of claim 1, wherein a set of uplink frequency resources is allocated for both D2R data of the AIoT data received from the AIoT device and R2D data of the AIoT data transmitted to the AIoT device.

14. The baseband processor of claim 1, wherein the first set of time resources is scheduled for the communication of the AIoT data including transmitting a carrier wave for the AIoT device.

15. A method performed by a base station, comprising:
transmitting, to an intermediate node, control information to schedule a set of time resources for communicating AIoT data, the AIoT data including D2R data transmitted from an Ambient Internet of Things (AIoT) device to the intermediate node and R2D data transmitted from the intermediate node to the AIoT device; and
scheduling an uplink transmission from the intermediate node non-overlapping with the set of time resources.

16. The method of claim 15, wherein a set of uplink frequency resources is configured for both the D2R data and the R2D data.

17. The method of claim 15, wherein a set of uplink frequency resources is allocated for the D2R data, and a set of downlink frequency resources is allocated for the R2D data.

18. The method of claim 15, wherein the transmitting of the control information comprising:
transmitting, to the intermediate node, a radio resource control (RRC) message that configures a D2R resource pool for the D2R data and a R2D resource pool for the R2D data; and
transmitting downlink control information (DCI) that activates or deactivates the intermediate node receiving the D2R data or transmitting the R2D data.

19. The method of claim 15, wherein the transmitting of the control information comprising:
transmitting, to the intermediate node, a first downlink control information (DCI) that indicates starting and lasting number of slots for the AIoT device to receive the D2R data; and
transmitting, to the intermediate node, a second DCI that indicates starting and lasting number of slots for the AIoT device to transmit the R2D data.

20. An apparatus, acting as an intermediate node to connect an ambient Internet of Things (AIoT) device and a base station, when executing instructions stored in a memory, configured to perform operations comprising:
receiving, from the base station, control information to allocate resources for AIoT communication; and
performing the AIoT communication with the AIoT device based on the allocated resources,
wherein the resources are allocated where an access link transmission between the intermediate node and the base station is time division multiplexed (TDMed) with the AIoT communication.
